(19) United States
(12) Patent Application Publication
(10) Pub. No.: US 2004/0078233 A1
(43) Pub. Date: Apr. 22, 2004

(54) Method and system for supporting therapy planning, particularly in the presence of multiple deficits

(76) Inventors: Klaus Abraham-Fuchs, Erlangen (DE); Uwe Eisermann, Kufstein (AT); Niels Richter, Thurnau (DE); Robert Setz, Rednitzhembach (DE)

Correspondence Address: HARNESS, DICKEY & PIERCE, P.L.C., P.O.BOX 8910, RESTON, VA, 20195, US

(21) Appl. No.: 10/612,032

(22) Filed: Jul. 3, 2003

(30) Foreign Application Priority Data
Jul. 3, 2002 (EP) 02014704.7

(51) Int. Cl. G06F 17/60

(52) U.S. Cl. 705/2

(57) ABSTRACT

A method and a system are for supporting therapy planning in rehabilitation in the presence of multiple deficits and are also for therapy planning for chronic illnesses in the presence of further illness-dependent restrictions. The method involves a capability or illness profile for a patient and also at least one first database being provided. The first database containes a plurality of therapy modules and/or treatable capabilities and also minimum prerequisites, associated with the therapy modules or treatable capabilities, for implementing the respective therapy modules or treating the respective treatable capabilities. A data processing station automatically compares the patient's capability or illness profile with the minimum prerequisites by accessing the first database and, on the basis of the comparison, advises a user of one or more suitable therapy modules and/or suitable treatable capabilities for which the minimum prerequisites are satisfied. The method and the associated system reduce the time involved in therapy planning for patients having multiple deficits or further illness-dependent restrictions to a considerable extent.

The present application hereby claims priority under 35 U.S.C. §119 on European patent application number EP 02014704.7 filed Jul. 3, 2002, the entire contents of which are hereby incorporated herein by reference.

### FIELD OF THE INVENTION

The present invention generally relates to a method and a system for supporting therapy planning in rehabilitation in the presence of multiple deficits, and also for therapy planning for chronic illnesses in the presence of restrictions prescribed by other illnesses.

### BACKGROUND OF THE INVENTION

Serious illnesses such as stroke, heart attack or Alzheimer's disease or serious operations such as the insertion of joint implants or the performance of an amputation cause most patients to have different deficits in physical and mental performance. These deficits are generally the result of the weakening or complete failure of a region of the brain or of a muscle. Combinations of these also frequently arise.

Thus, by way of example, a region of the brain which is responsible for controlling a muscle or a number of muscles in functional chains can be damaged. As a result, the affected muscles degenerate. Thus, they are no longer able to be used properly. Such mental or physical restrictions are referred to in the medical vernacular as capability deficits, which can be split into various areas of capability. Thus, one known classification makes the following exemplary distinctions:

motor capabilities such as strength, stamina, mobility, balance, reaction, orientation, differentiation, accommodation, speech motor functions;

intellectual/cognitive capabilities such as attention, memory, planning, comprehension of speech, communication, vision;

organic/physical capabilities such as reduction of organ performance;

social capabilities such as the ability to communicate and participate;

emotional capabilities such as the capability to develop self-esteem.

Some capabilities also require interplay between motor functions and cognitive functions. Thus, by way of example, the activity of climbing stairs requires strength and balance as motor capabilities and attention and spatial awareness as cognitive capabilities.

Very often, a patient does not have a single deficit in one capability category, but rather has a combination of a plurality of deficits in a more or less serious form. The aim of a therapeutic measure, which is normally performed as part of a rehabilitation process, is to restore the capabilities or to reduce the existing deficits as far as possible.

At the start of the rehabilitative measure, this generally involves all the patient's capability deficits being recorded using known methods of measurement, observation and questioning, and their extent being documented. This recording process is also referred to as staging the patient. Depending on the method of measurement used, the result of this staging process is quantitative, for example a percentage of visual capability or an indication of the degree of mobility in the upper arm, or qualitative, for example a classification of the capability restriction as severe, intermediate or slight. One example of an established method of measurement for staging numerous neurological, cognitive and psychological capabilities is the “Wiener test series” from the company Schuhfried.

The result of this initial examination is ideally a cross-discipline capability report which can be presented in the form of a capability profile. In this context, a capability profile is defined as a list of all relevant capabilities and an association between the degree of the restriction in these capabilities for this patient and the time at which the information was collected.

In addition to the term capabilities, the term skill is also used in the medical vernacular. In the context of a medical rehabilitation measure, a skill is understood to mean a complex action but one which is self-contained and can be delimited with respect to other actions. A skill requires interplay between a plurality of capabilities. In particular, the term skill in the context of rehabilitation refers to activities of daily living (ADL) which are a primary prerequisite for independent, autonomous living. Examples of such skills are eating, dressing, washing, showering, climbing stairs, etc. The performance of such skills is also recorded in standardized questionnaires and is quantified as an ADL index. Although rehabilitation directly involves the training of capabilities, the actual aim is to reacquire skills. In this respect, the terms capability and skill can normally be interchanged within the context of the description below.

Normally, a patient simultaneously has a plurality of capability deficits which can belong to various capability categories in line with the preceding classification. During therapy planning for patients with such multiple deficits, the physician needs to consider reciprocal dependencies in the treatment of the individual capability deficits, even if said capability deficits do not come under his area of competence. To date, this requires appointments, oral consultations and the exchange of written documents between the relevant organization units at the hospital or at the rehab clinic, between the treating physicians and therapists and between different service providers in an integrated health service, in order to be able to carry out therapy planning for patients having multiple deficits. This makes therapy planning time-consuming for the individual physician or therapist and carries the hidden risk of individual dependencies being overlooked in therapy planning.

A comparable problem arises with therapy planning for chronic illnesses, such as diabetes, asthma or the like. In this case too, therapy planning is made more difficult for the physician when there are further health and physical restrictions which are dependent on other illnesses in the patient.

### SUMMARY OF THE INVENTION

Against the background of this situation, an object of an embodiment of the present invention is to specify a method and a system for supporting therapy planning in the presence of multiple deficits or restrictions dependent on other illnesses in the patient which reduce the time involvement for the physician or therapist during therapy planning.

An object may be achieved by way of a method and the system. Advantageous refinements of the method and of the system can be found in the description below and in the exemplary embodiments.

In a first alternative for an embodiment of the method, to support therapy planning in the presence of multiple deficits, a capability profile for a patient and also a first database are provided, the first database containing a plurality of therapy modules and/or treatable capabilities and also minimum prerequisites of capabilities, the minimum prerequisites being associated with the therapy modules or treatable capabilities, for implementing the respective therapy modules or treating the respective treatable capabilities. In the case of this alternative, therapy modules are to be understood to mean individual exercises which the patient needs to perform in order to regain individual capabilities.

A therapy module can include, by way of example, ergometer training or a balance exercise. In the present context, capability can also be understood to mean a skill, in which case the therapy module can then be designed for training a specific skill. In this case, the capability profile can be retrieved from a database or else input directly by the user in response to a request by the data processing station. An embodiment of the method involves a data processing station automatically comparing the patient's capability profile with the minimum prerequisites by accessing the first database and, on the basis of the comparison, advising a user of one or more suitable therapy modules and/or suitable treatable capabilities for which the minimum prerequisites are satisfied. The minimum prerequisites associated with the therapy modules or treatable capabilities contained in the database comprise at least one or more further necessary capabilities and preferably the extent to which these capabilities need to be present for implementing the respective therapy module or treating the respective treatable capability. In this context, the patient's capability profile is preferably provided by a second database, from which it is retrieved by the data processing station. This second database can also be an electronic patient record for the patient. Preferably, the first database contains only therapy modules or treatable capabilities which are available to the user for treating the patient. Thus, the first database can be individually matched to its place of use, for example the respective hospital or the respective specialist department, and to the therapy opportunities available there.

In a second alternative for an embodiment of the method, to support therapy planning for chronic illnesses in the presence of further restrictions prescribed by other illnesses, an illness profile for a patient, which includes health-related and physical properties of the patient, and a first database are provided, the first database containing a plurality of therapy modules for treating chronic illnesses and also minimum prerequisites of health-related and physical properties, the minimum prerequisites being associated with the therapy modules, for implementing the respective therapy modules. In the case of this alternative, therapy modules are understood to mean actions which the patient needs to perform in order to treat his chronic illness.

By way of example, a therapy module can comprise a time plan for performing inhalations or for applying an ointment. In the case of the present method, a data processing station automatically compares the patient's illness profile with the minimum prerequisites by accessing the first database and, on the basis of the comparison, advises a user of one or more suitable therapy modules for which the minimum prerequisites are satisfied. In this context, the patient's illness profile is preferably provided by a second database, from which it is retrieved by the data processing station. This second database can also be an electronic patient record for the patient. Preferably, the first database contains only therapy modules which are available to the user for treating the patient. Thus, the first database can be individually matched to its place of use, for example the respective hospital or the respective specialist department, and to the therapy opportunities available there.

An embodiment of the method and the associated system provide the user, particularly the physician or therapist, with a computer-based auxiliary means which he can use to carry out reliable therapy planning for patients having multiple deficits, or when there are further restrictions prescribed by other illnesses, with a reduced time involvement. The method or the associated system automatically evaluates the patient's capability or illness profile and, by reverting to one or more knowledge bases in the form of one or more databases, advises of the suitable therapy modules or treatable capabilities which satisfy the reciprocal dependencies when treating multiple deficits or when there are further illness-dependent restrictions. The user can then select the advised treatable capabilities or therapy modules and compile them to give a therapy plan. In doing this, he no longer needs to take into account any reciprocal dependencies, since this has already been done automatically by the data processing station.

The present invention is explained in more detail below in relation to the first alternative for the method. However, these explanations can also be readily applied to the second alternative for the method if the capability profile is replaced with the illness profile, in which case the minimum prerequisites then relate to health-related and physical properties of the patient.

Naturally, the patient's capability profile or skills profile needs to be up-to-date when carrying out an embodiment of the method so that it is possible to mark the individual dependencies and the capabilities which are to be treated correctly. In one alternative for an embodiment of the method, the first database can, as a first knowledge base, contain just the therapy modules with the associated minimum prerequisites. In this context, the minimum prerequisites include all capabilities relevant to the implementation of the respective therapy module and the extent of the capability which is necessary for implementing the therapy module. By way of example, such a minimum prerequisite is the condition that capability X needs to be at least Y % present if the corresponding therapy module is to be prescribed.

Alternatively or in addition to this first knowledge base, a second knowledge base can be implemented in the first database or can be provided as a further database containing a matrix of treatable capabilities and/or skills and also an allocation of minimum prerequisites of other capabilities or skills F1 . . . FN for the therapy of the capability FX. Thus, by way of example, a minimum prerequisite can be that the capabilities F1 . . . FN need to be at least Y % present in order to be able to treat the capability X. Preferably, the first and second knowledge bases contain only the therapy modules which are available to the respective user or the capabilities which the user can treat. In this way, only therapy modules or capabilities which come under the respective physician's area of competence are output.

The quantified dependencies in the two knowledge bases are allocated essentially from experience gained by specialists in this field when treating patients. In different forms of the present method and of the associated system, this knowledge can be obtained by questioning one or more experts, for example, and can be stored in the first database. In another embodiment, the respective knowledge base is filled in conjunction with the future end user only when it is installed in an organization. This practice has the advantage that the user can include his specific experience and the constraints of his organization when creating the knowledge base. Regardless of this, the databases contain generally valid knowledge which is independent of a patient's individual situation.

The advice of the one or more suitable therapy modules and/or suitable treatable capabilities is preferably given by virtue of the data processing station outputting exclusively the therapy modules or treatable capabilities, for example by displaying them on a monitor, for which the minimum prerequisites are satisfied. In another refinement, the advice can be given by virtue of those therapy modules and/or treatable capabilities for which the minimum prerequisites are satisfied being marked, for example graphically highlighted, in an output of a relatively large number of therapy modules and/or treatable capabilities.

In addition, the suitable therapy modules or suitable treatable capabilities can be enabled for access by the user and/or the therapy modules or treatable capabilities which accordingly do not satisfy the minimum prerequisites can be disabled for access by the user during computer-assisted therapy planning. Naturally, this disabling or enabling of a module or of a capability is to be understood only to be a decision-supporting indication by the system. The user, particularly the physician or therapist, always has the option of manually changing the disabling or enabling if he thinks this is appropriate on the basis of his experience. In the event of a manual change, there is the option of specifying a reason for this change, which is stored, in an input field.

As an addition to marking of disabling, it is possible to specify the reason that disabling has occurred, for example the capability deficit considered to be the excluding criterion for use of the therapy module. For the sake of better clarity, this detailed information can also first appear when the user requests it, for example by clicking on the disabled module with the mouse (link to the cause of disabling).

Preferably, an embodiment of the method and the associated system output only the treatable capabilities which match capabilities to be treated which are ascertained by the data processing station or a program module contained therein on the basis of the capability profile. This relates to all skills or capabilities in the capability profile for which there are deficits.

In another refinement of an embodiment of the method or system, a third database is provided which contains an association between target capabilities and the therapy modules. Target capabilities are understood to mean the capabilities which are trained with the corresponding module. In this context, the data processing station is designed such that it outputs the association together with the therapy modules and/or outputs only the therapy modules for which the target capabilities match one or more capabilities to be treated which have been input by a user beforehand or have been automatically ascertained by the data processing station on the basis of the capability profile.

In another embodiment, a fourth database is provided which, like the third database, can also be part of the first database. This fourth database contains an allocation of further minimum prerequisites, relating particularly to health-related and physical properties of the patient, for implementing the therapy modules and/or treating the treatable capabilities. These further minimum prerequisites comprise requirements and excluding criteria for every therapy module beyond restrictions which are dependent on multiple deficits. Thus, this database can contain, by way of example, information that when implementing the therapy module X, cardiac insufficiency, osteoporosis, pregnancy, a cardiac pacemaker, a joint implant, Parkinson's disease, etc. must not be present, for example.

In addition, by way of example, it can be specified that, to implement the therapy module X, further criteria need to be satisfied, for example that the patient must not be above a prescribed maximum age and must not be below a prescribed minimum age, that his body weight needs to be within a particular range, or that the patient needs to be of a particular sex. These further minimum prerequisites are likewise automatically checked by the data processing station or the module contained therein and are taken into account in the comparison. In this context, the associated patient data can be retrieved from a further database or from an electronic patient record. In addition, the necessary patient information can also be requested interactively by the user on the computer workstation or can be obtained by accessing a hospital information system (HIS). In an embodiment of the method, in a similar manner to the check on the minimum prerequisites of the capabilities, this check on the further minimum prerequisites enables one or more therapy modules, or in the event of nonsatisfaction disables them and possibly again provides them with an appropriate indication of the cause of disabling.

An embodiment of the method preferably involves a current capability profile for the patient being retrieved a plurality of times in the course of therapy and automatically being compared with the minimum prerequisites. If such a comparison provides different results than in the preceding comparison, then a message or an indication to the user, particularly the competent therapist or physician, is automatically generated in order to advise him of the change. At the same time, therapy modules affected are enabled or disabled according to whether the minimum prerequisites are satisfied or not satisfied. In this way, the user is always provided with information about a change in the decision principles which are of importance to therapy planning, even if these are based on training results which do not come under his area of competence.

Thus, by way of example, training which the patient carries out in another organization unit with a physician's colleague can result in a level being achieved for a capability which now provides the minimum prerequisites for implementing a particular therapy module which was disabled at the start of therapy on account of the minimum prerequisites not being satisfied. The user is advised of this by the generated indication or by particular marking of this therapy module in the output, and the user can then align the therapy plan as appropriate by including the newly available therapy module.

The method can be repeatedly carried out in this manner in the course of therapy at regular intervals of time or else just when there is a change in the patient's capability profile. This involves the capability profile being regularly checked. The indication of the change's resultant reassessment of the therapy modules or treatable capabilities can be given to the competent physician or therapist by means of e-mail, fax or the like, for example.

In another refinement of an embodiment of the method and of the associated system, the first database contains not just the minimum prerequisites for capabilities for implementing the respective therapy modules but also the prerequisites for implementing individual difficulty or stress levels in therapy modules. The already described functions for disabling, enabling and notification are then used not just for concluded therapy modules but also for the corresponding levels within the therapy modules. By checking the patient's capability profile, it is then similarly possible for a difficulty level to be automatically disabled or enabled and for this to be displayed to the user, for example on a monitor, or for a message to be automatically sent to the user.

The associated system for supporting therapy planning accordingly includes a data processing station, which is connected to the first database, and a module for automatically comparing a prescribable capability or illness profile with the minimum prerequisites contained in the database by reverting to the first database and for advising of one or more suitable therapy modules and/or suitable treatable capabilities for which the minimum prerequisites are satisfied on the basis of the comparison.

In the further refinements of the system, the data processing station is also connected to the second, third and fourth databases, which have already been explained in connection with the method. In this context, the module is respectively designed to carry out the automated method steps explained in connection with the method.

### BRIEF DESCRIPTION OF THE DRAWINGS

The present method and the associated system are explained again briefly below using an exemplary embodiment in connection with the drawings, without limiting the general inventive concept. In the drawings:

FIG. 1 shows an example of a capability profile for a patient (as an excerpt);

FIG. 2 shows an example of the association between therapy modules and minimum prerequisites of capabilities in the first database;

FIG. 3 shows an example of a status display for the therapy modules, which gives advice of suitable therapy modules; and

FIG. 4 shows an overview of the present method and of the associated system in one embodiment of the invention.

### DETAILED DESCRIPTION OF THE PREFERRED EMBODIMENTS

In the present exemplary embodiment, the process of therapy planning by a physician or therapist using the present method and the associated system in one specific form is explained by way of example. The exemplary system includes a computer workstation (data processing station 10) for therapy planning and therapy progress control with a module 16 for automated evaluation of the data. The data processing station 10 is connected to various databases, from which the module 16 retrieves the necessary information. The basic equipment for this exemplary system includes a database 12 with an individual capability profile for the patient, a first knowledge database 11 with therapy modules and an allocation of minimum prerequisites of capabilities, a second knowledge database 11a with treatable capabilities and an allocation of minimum prerequisites of other capabilities or skills for therapy for this capability, and a third database 13 with an association between therapy modules and target capabilities receiving therapy using the respective therapy module.

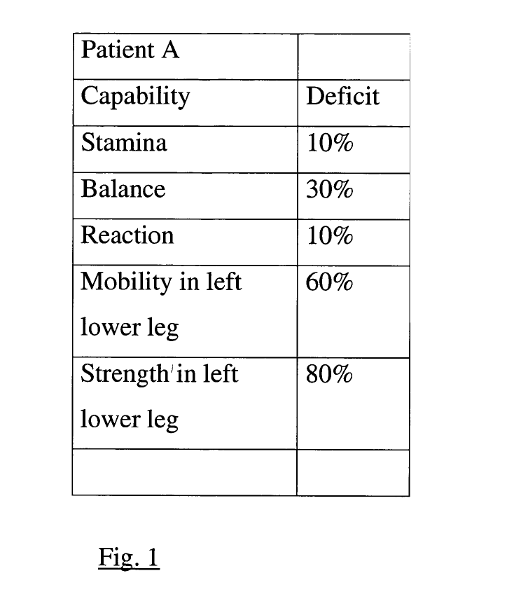

An example of a capability profile as contained in the second database 12 is shown as an excerpt in FIG. 1. This capability profile comprises different capabilities, such as stamina, balance, etc. with the respective deficit, i.e. the percentage by which the respective capability in this patient is reduced with respect to the 100% capability of a healthy comparative person.

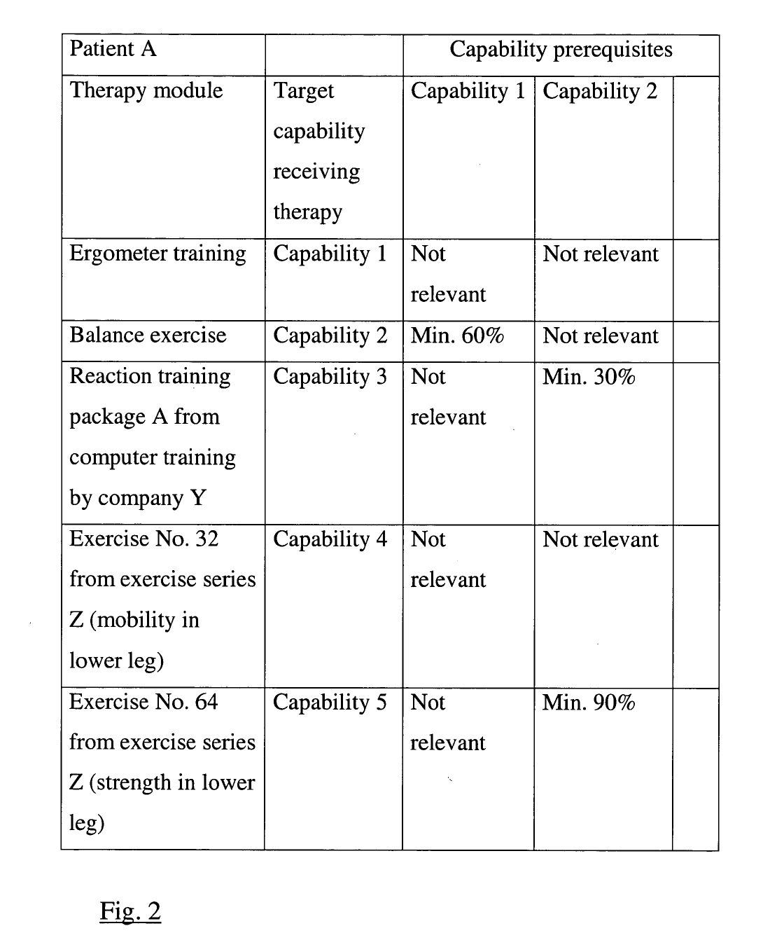

The knowledge database 11 includes all the therapy modules which are available to the user in his organization unit, for example at the hospital or in the specialist department, and an allocation of minimum prerequisites of all capabilities which are relevant to implementation of the respective therapy module. The content of this database is shown, by way of example, in columns 1 and 3 ff. in FIG. 2. In this case, the individual capabilities are merely numbered consecutively in the present illustration for the sake of simplicity, but in the database they are indicated specifically or are associated with the numbering. By way of example, this knowledge database 11 can show that, for implementing the “Reaction training package A from computer training by company Y” therapy module, the capability 1 is not relevant but the capability 2 needs to be at least 30% present. This therapy module can therefore be prescribed only if the patient has at least 30% control over capability 2. The same design applies to the second knowledge database 11a, in which the therapy modules are merely replaced with the corresponding treatable capabilities, for example “Capability 3” instead of “Reaction training package A from computer training by company Y”. This second knowledge database 11a can be in the form of a separate database or can be part of the first knowledge database 1.

The fourth database 14, which can likewise be part of the knowledge database 11, comprises a list of the available therapy modules and an allocation of the target capability or target capabilities which can be treated by the respective therapy module. The content of this database 14 thus corresponds to the first two columns in FIG. 2.

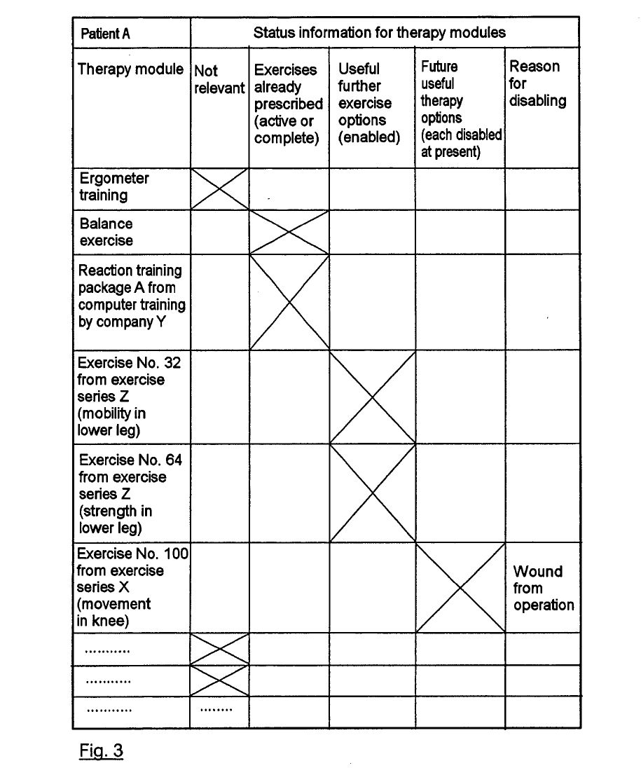

When using an embodiment of the present method or the associated system, the physician or therapist involved in therapy planning on the computer workstation 10 has access to a list of all the therapy modules which are available to him for prescribing. In the present example, automatic evaluation of the patient database (second database 12), of the knowledge databases 11, 11a and of the fourth database 14 lists for the physician or therapist all the available therapy modules on a monitor on the computer workstation 10 and provides them with status information from which it is possible to see which of these therapy modules he can prescribe for the patient on the basis of his capability profile. In this full and clear status display of the therapy requirement and of the possible therapy options, as shown by way of example in FIG. 3, the physician or therapist can carry out suitable therapy planning without any great time involvement. The therapy modules for which the patient satisfies the corresponding minimum prerequisites are marked or enabled. Therapy modules for which the patient does not satisfy the minimum prerequisites for capabilities are marked as disabled. As an addition to the disabled marking, the reason for disabling is also indicated in the present case. The planner thus has an immediate overview of the therapy options actually available, which can additionally be graphically highlighted if appropriate. The type of display, as shown in FIG. 3 merely for the purposes of illustration, can also be made much clearer graphically.

In the present example, the therapy modules which do not require treatment in the patient are additionally marked as not relevant or are masked completely. These are, in particular, therapy modules with target capabilities which the patient already possesses to 100% or approximately 100%. In addition, the physician or therapist can also prescribe capabilities which need therapy by way of an appropriate input. Besides the therapy modules which are appropriate and can be used or are enabled at the time at which the capability profile is recorded, the example in FIG. 3 also indicates modules already prescribed in the past, which can still be active or may have already been concluded. All therapy modules which are appropriate for the future but cannot yet be used at the moment on account of existing multiple deficits can also be appropriately marked and disabled in the display.

The physician or therapist is naturally able to change the disabling or enabling of a therapy module manually if he thinks that this is appropriate on the basis of his experience. For the continued therapy planning, he then selects the correspondingly enabled therapy modules or a subselection thereof and compiles them into a therapy plan for the patient. In this context, the system is preferably designed such that the disabled therapy modules cannot be used for such planning on the computer workstation. Naturally, the same also applies for planning on the basis of the treatable capabilities instead of the therapy modules.

In a further embodiment of the exemplary system, a third knowledge database 3 is available which in turn includes the available therapy modules and an allocation of further requirements and excluding criteria for each therapy module beyond restrictions dependent on multiple deficits. These further minimum prerequisites can, as already mentioned further above, be particular illnesses or implants and also fundamental patient data, such as age, sex or weight. To check the presence of the corresponding additional minimum prerequisites in the patient, a further database 12a, for example in the form of an electronic patient record, is available which contains these further data. In this case too, the database 11 containing the capability profile can naturally be combined with the database 11a containing the further patient data.

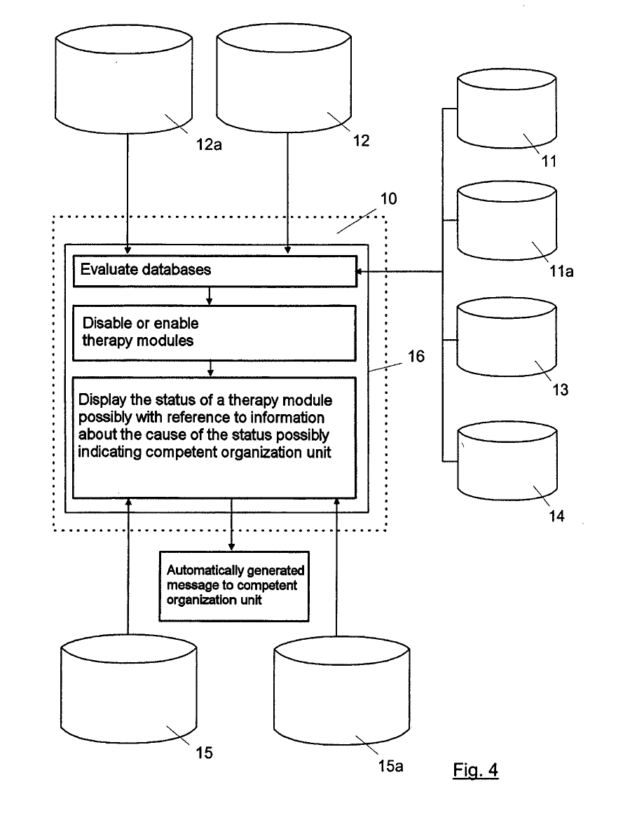

The corresponding marking and disabling or enabling of therapy modules by the module 16 in the data processing station 11 is done by evaluating all relevant databases, as shown schematically in FIG. 4. The corresponding therapy modules are displayed with their status or their marking preferably on a monitor. It goes without saying that they can also be displayed in another form, for example by virtue of output on a printer. FIG. 4 shows a further refinement of the present system and of the present method in which the data processing station 10 has access to further databases 15, 15a in which individual capabilities or therapy modules are associated with organization units, possibly broken down according to organization categories. Using these further databases 15, 15a, the planning therapist or physician additionally has an overview of those relevant therapy modules for which other organization units, for example other physicians or specialist departments, are responsible.

In particular, in the course of controlling therapy success and when matching the therapy to the progress of therapy, he sees which deficits are simultaneously being treated by other specialist departments which are currently displaying excluding criteria for an otherwise appropriate therapy module in his area of responsibility. With corresponding improvement of these deficits beyond a critical threshold value which corresponds to the minimum prerequisite of the otherwise appropriate therapy module, the previously disabled therapy module is immediately enabled in the overview which is output. This can be marked by a particular indication flag. In addition, a message to the organization unit which is responsible for the now enabled therapy module, particularly to the physician or therapist responsible there, can automatically be generated and transmitted.

In addition, when there is a change in the database containing the patient's capability profiles or when there is a change in the patient's electronic patient record, the system can automatically check whether a relevant threshold value for a deficit—a minimum prerequisite—in the patient, which results in a therapy module being disabled or enabled, is exceeded or undershot by the current change in the patient's condition. In this case too, it is possible to send the respectively competent organization unit or the competent physician or therapist a message, for example by e-mail or fax, so that said physician or therapist is immediately made aware of the indication of a necessary change if a therapy module is disabled or of an appropriate change if a therapy module is enabled, even if he is currently not using the therapy planning workstation. This requires repeated checking of the patient's capability profile in the second database 12 or in the electronic patient record 12a by the data processing station 10.

By using databases and graphical user interfaces on a computer workstation, the method and associated system illustrated by way of example automatically provide the treating physician or therapist with information which is relevant to the admissibility of prescribing a therapy module in the work cycle of therapy planning and therapy progress control for treating capability deficits. The planner is given an immediate overview of the therapy options for therapy planning which are actually available when the multiple deficits and any other restrictions are taken into account.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for supporting therapy planning in the presence of multiple deficits, comprising:
providing a capability profile for a patient and providing a first database, the first database containing a plurality of at least one of therapy modules and treatable capabilities and containing minimum prerequisites of capabilities, the minimum prerequisites being associated with the at least one of therapy modules and treatable capabilities, for at least one of implementing the respective therapy modules and for treating the respective treatable capabilities;
automatically comparing, at a data processing station, the patient's capability profile with the minimum prerequisites by accessing the first database; and
advising a user, based on the comparison, of at least one of at least one therapy module and at least one treatable capability for which the minimum prerequisites are satisfied.

2. A method for supporting therapy planning for chronic illnesses in the presence of further restrictions prescribed by other illnesses, comprising:
providing an illness profile for a patient, including health-related and physical properties of the patient, and providing a first database, the first database containing a plurality of therapy modules for treating chronic illnesses and containing minimum prerequisites of health-related and physical properties, the minimum prerequisites being associated with the therapy modules, for implementing the respective therapy modules;
automatically comparing, at a data processing station, the patient's illness profile with the minimum prerequisites by accessing the first database; and
advising a user, based on the comparison, of at least one therapy module for which the minimum prerequisites are satisfied.

3. The method as claimed in claim 1, wherein the advice of the at least one of at least one therapy module and at least one treatable capability is given by virtue of exclusively the at least one of at least one of the therapy module and the treatable capability being output.

4. The method as claimed in claim 3, wherein the advice of the at least one of at least one of the therapy module and treatable capability is given by virtue of the at least one of at least one of the therapy module and treatable capability being marked in the output.

5. The method as claimed in claim 1, wherein the patient's capability is retrieved from a second database by the data processing station.

6. The method as claimed in claim 1, wherein at least one of the at least one therapy module and at least one treatable capability is enabled for access, and remaining at least one therapy module and remaining treatable capability for which the minimum prerequisites are not satisfied is disabled for access.

7. The method as claimed in claim 6, wherein at least one of the at least one disabled therapy module and capability is provided with an indication of the reason for disabling in the output.

8. The method as claimed in claim 6, wherein an indication of the reason for disabling is output for the disabled at least one of the at least one therapy module and capability following an appropriate input from the user.

9. The method as claimed in claim 6, wherein at least one of the at least one disabled therapy module and capability is adapted to be individually enabled by manual input from a user.

10. The method as claimed in claim 1, wherein the data processing station outputs only the treatable capabilities which match capabilities to be treated which are ascertained by the data processing station on the basis of the capability profile.

11. The method as claimed in claim 1, wherein a third database, at least one of separate from and part of the first database, is provided which contains an association between target capabilities and the therapy modules, where the data processing station at least one of outputs the association together with the at least one therapy module and outputs only the therapy modules for which the target capabilities match at least one capability to be treated which at least one of have been input previously and have been ascertained by the data processing station on the basis of the capability profile.

12. The method as claimed in claim 1, wherein the data processing station outputs the therapy modules with a status indicator which includes information about prescription of the therapy modules at least one of which has already taken place and about future suitability of the therapy modules on the basis of the presence of particular prerequisites.

13. The method as claimed in claim 1, wherein further patient data and also a fourth database, at least one of separate from and part of the first database, are provided, said fourth database containing an allocation of further minimum prerequisites for at least one of implementing at least one therapy module and treating the treatable capabilities, and the data processing station takes into account the further minimum prerequisites in the comparison.

14. The method as claimed in claim 1, wherein, in the course of therapy, at least one of a current capability and illness profile for the patient is retrieved a plurality of times by the data processing station and is automatically compared with the minimum prerequisites in order, in the event of a change in at least one of the capability and illness profile which affects satisfaction of the minimum prerequisites of at least one individual therapy module and treatable capability, to automatically generate an indication to the user and to at least one of disable and enable at least one of the therapy module and capability in question if appropriate.

15. The method as claimed in claim 14, wherein at least one of the current capability and illness profile is retrieved at least one of at prescribable intervals of time and following a message which is automatically generated in the event of a change in at least one of the capability and illness profile.

16. The method as claimed in claim 14, wherein the indication to the user is sent by the data processing station using an electronic medium.

17. The method as claimed in claim 1, wherein the data processing station at least one of enables and disables individual sublevels within the therapy modules on the basis of satisfaction of the minimum prerequisites.

18. A system for supporting therapy planning in the rehabilitation of a patient, comprising:
a data processing station, coupled to a first database containing a plurality of at least one of therapy modules and treatable capabilities and minimum prerequisites of capabilities, said minimum prerequisites being associated with at least one of the therapy modules and treatable capabilities, for at least one of implementing the respective therapy modules and treating the respective treatable capabilities; and
a module for automatically comparing a prescribable capability profile with the minimum prerequisites by reverting to the first database and for advising of at least one of at least one therapy module and at least one treatable capability for which the minimum prerequisites are satisfied on the basis of the comparison.

19. A system for supporting therapy planning for chronic illnesses in a patient, comprising:
a data processing station, coupled to a first database containing a plurality of therapy modules for treating chronic illnesses and minimum prerequisites of health-related and physical properties, said minimum prerequisites being associated with the therapy modules, for implementing the respective therapy modules; and
a module for automatically comparing a prescribable illness profile, including health-related and physical properties of the patient, with the minimum prerequisites by reverting to the first database and for advising of at least one therapy module for which the minimum prerequisites are satisfied on the basis of the comparison.

20. The system as claimed in claim 18, wherein the module is designed to output exclusively the at least one treatable capability.

21. The system as claimed in claim 20, wherein the module is designed to output the at least one treatable capability and to mark the at least one treatable capability in an output on a monitor.

22. The system as claimed in claim 18, wherein the module is designed to enable the at least one treatable capability for at least one of access and to disable remaining at least one treatable capability for access for which the minimum prerequisites are not satisfied.

23. The system as claimed in claim 18, wherein the data processing station is connected to a second database from which the capability profile can be retrieved.

24. The system as claimed in claim 18, wherein the module is designed to output exclusively the at least one treatable capability which match capabilities to be treated which are ascertained by the module on the basis of the capability profile.

25. The system as claimed in claim 18, wherein at least one of the first database and a third database, to which the data processing station is coupled, contains an association between target capabilities and the therapy modules, and the module is designed to at least one of output the association together with the at least one therapy module and to output exclusively the at least one therapy module for which the target capabilities match at least one capability to be treated which at least one of has been input previously and has been ascertained by the module on the basis of the capability profile.

26. The system as claimed in claim 18, wherein at least one of the first database and a fourth database, to which the data processing station is coupled, contains an allocation of further minimum prerequisites for at least one of implementing the therapy modules and treating the treatable capabilities, and wherein the module is designed to take into account the further minimum prerequisites in the automatic comparison.

27. The method as claimed in claim 3, wherein the output advice is displayed on a monitor.

28. The method as claimed in claim 4, wherein the marked output advice is displayed on a monitor.

29. The method as claimed in claim 2, wherein the patient's illness profile is retrieved from a second database by the data processing station.

30. The method as claimed in claim 15, wherein the indication to the user is sent by the data processing station using an electronic medium.

31. The system as claimed in claim 19, wherein the module is designed to output exclusively the at least one therapy module.

32. The system as claimed in claim 20, wherein the output includes display on a monitor.

33. The system as claimed in claim 31, wherein the output includes display on a monitor.

34. The system as claimed in claim 31, wherein the module is designed to output the at least one therapy module and to mark the at least one therapy module in an output on a monitor.

35. The system as claimed in claim 19, wherein the module is designed to enable the at least one therapy module for at least one of access and to disable remaining at least one therapy module and for access for which the minimum prerequisites are not satisfied.

36. The system as claimed in claim 19, wherein the data processing station is connected to a second database from which the illness profile can be retrieved.
